(19) United States
(12) Patent Application Publication
(10) Pub. No.: US 2012/0175384 A1
(43) Pub. Date: Jul. 12, 2012

(54) SEALED CONTAINER COMPRISING A DISPLACEABLE PISTON

(75) Inventors: Andy Greter, Baar (CH); Mathey Vukic, Baar (CH)

(73) Assignee: MEDMIX SYSTEMS AG, Rotkreuz (CH)

(21) Appl. No.: 13/497,068

(22) PCT Filed: Sep. 17, 2010
(86) PCT No.: PCT/CH2010/000227

§ 371 Date: Mar. 20, 2012

(30) Foreign Application Priority Data
Sep. 22, 2009 (CH) 01462/09

(51) Int. Cl. B67D 7/70; B67B 1/00; G01F 11/00; B65B 1/04

(52) U.S. Cl. 222/137; 141/2; 222/386; 222/327; 222/153.02; 222/153.05; 222/153.06

(57) ABSTRACT

A syringe-type container comprising a hollow main body with a distal outlet opening and a proximal actuation opening for inserting an actuation element. A piston is displaceably arranged inside the main body for discharging a flowable product from the container. To reduce the permeability of the container, the main body has a diffusion-reducing layer. The outlet opening is closed with a first removable or severable seal, and the actuation opening is closed with a second seal.

### TECHNICAL FIELD

The present invention relates to a container with a main body, in the interior of which a piston is displaceably arranged. Such containers are referred to hereinbelow as syringe-like containers.

### PRIOR ART

Syringes and syringe-like containers are known for many uses in the medical and non-medical fields. Thus, a normal disposable injection syringe comprises a hollow cylindrical syringe body made of plastic, in which a piston is displaceably arranged. The piston is generally connected fixedly to a piston rod, which extends out of the syringe body in the proximal direction. An actuation flange is generally formed on the proximal end of the piston rod, and two mutually opposite holding flanges are generally formed on the syringe body. The syringe is held between index finger and middle finger or ring finger. The thumb is used to apply pressure to the actuation flange, such that a product located in the syringe is discharged through a distal outlet opening. The corresponding counterforce is taken up by the holding flanges.

Similarly, multiple syringes are also known, which comprise two or more interconnected syringe bodies arranged in parallel or concentrically and in which two or more identical or different components are received and from which the components can be discharged by displacement of corresponding pistons. These components can, for example, be two different components of a pharmaceutical product that are intended to be mixed with each other just shortly before administration, or two or more components of a bone cement. They can also conceivably be, for example, two or more components of a medical or nonmedical glue, e.g. of a fibrin-based medical glue. Many other uses of multiple syringes are known or conceivable. Such multiple syringes are often designed to be connected to a mixer, such that the components to be ejected can be mixed together directly after leaving the multiple syringe. The pistons are often interconnected via a common actuation element.

Syringe-like containers are also used in the form of cartridges for special discharge devices (dispensers). In this case, the outer shape of the container is often adapted to the use in a defined dispenser. A dispenser with a cartridge for two components is disclosed, for example, in WO 2008/009143.

In some uses, it is desirable or necessary that the product to be ejected is stored directly in a syringe-like container over quite a long period of time. The product can, for example, be a highly volatile, aggressive, hygroscopic or oxygen-sensitive substance. However, many commercially available plastics, e.g. the frequently used polyethylene, have a relatively high permeability and therefore form an inadequate barrier against diffusion of contents from the interior of the container to the outside or diffusion of foreign substances such as water or volatile substances and gases from the outside into the interior of the container. Products stored in a container made of such a plastic can therefore undergo undesirable changes in their properties during long periods of storage. In the prior art, therefore, glass syringes are often used, since glass is practically impervious to all routinely used substances. Since glass is a brittle material and difficult to handle, this is often unsatisfactory.

For ampules, i.e. containers that are completely closed all the way round, which are opened by irreversible destruction, it is known to completely envelop a plastic ampule with a metallic coating as diffusion barrier in order to reduce the permeability. An ampule of this kind is disclosed in WO 2006/085063, for example. The coating is applied after the ampule has been filled. It is not possible to fill the ampule after the coating has been applied. Moreover, the latter document provides no indication of how a sufficient diffusion barrier can be obtained in the case of a syringe-like container that has several openings.

EP 1 486 584 discloses a plastic tube which has an open end and which is closed at this end by a stopper. A continuous coating surrounds both the tube and also the stopper. It is therefore not possible to fill the tube without breaking the coating.

DE 44 45 969 discloses a plastic syringe provided with a diffusion-reducing coating. A closure cap is fitted onto the syringe head and is taken off prior to the discharging procedure. However, the diffusion tightness of such a syringe can be improved still further.

### SUMMARY OF THE INVENTION

It is an object of the present invention to make available a syringe-like container whose main body is made substantially of plastic, which container has reduced permeability.

This object is achieved by a container having the features of claim 1. Further embodiments are set forth in the dependent claims.

The present invention further relates to a method for producing a container with a product located in the latter, said method having the features of claim 14.

Thus, a container is proposed comprising a hollow main body with an interior, an outer surface, a distal outlet opening, and a proximal actuation opening, wherein the actuation opening is suitable and configured for inserting an actuation element into the interior of the main body. A piston is displaceably arranged in the interior of the main body, such that a flowable product present in the interior of the main body between piston and outlet opening can be discharged from the container. In order to reduce the permeability of the container, the main body has a diffusion-reducing barrier layer, the outlet opening is closed by a first breakable and/or removable seal, in particular a pull-off seal, and the actuation opening is closed by a second breakable and/or removable seal, in particular a pull-off seal. The first seal is preferably cohesively bonded onto a first application surface surrounding the first outlet opening, and the second seal is preferably cohesively bonded onto a second application surface surrounding the second outlet opening.

In this way, a container is obtained which, on the one hand, has very low permeability for small molecules through the container wall and thus has an improved diffusion tightness. On the other hand, gas or liquid exchange through the outlet opening or through a sealing gap between piston and container wall and onward through the actuation opening is also prevented or at least greatly reduced as a result of the seals. In this way, such a container is suitable for long-term storage of the product contained in the container. When the product is to be discharged from the container, the seals can simply be broken or removed, e.g. by piercing them or pulling them off.

The product received in the container can be any kind of flowable product compatible with the material of the main body, in particular a liquid, a suspension or emulsion, a gel, a paste or another form of flowable product of high viscosity, a powder, etc. The product is received in a product-receiving area of the container, which area is preferably delimited directly by the main body, the piston and the first seal, i.e. there is no further enclosure between the product and the main body, the piston and the first seal. The container is thus opened directly for product discharge by breaking or removing the first seal. However, it is also possible in particular to provide a further closure piece, e.g. a septum, which additionally closes the distal outlet opening. Such an additional closure piece is then preferably arranged within that area of the container that is closed by the first seal, such that the first seal effectively reduces a diffusion that could still take place through the additional closure piece on its own.

The diffusion-reducing barrier layer is preferably applied to the outer surface of the container. It can be provided with one or more further layers, e.g. a protective layer. However, it can also be present on an inner face of the container. The thickness of the barrier layer is preferably ca. 20 nanometers to 20 micrometers. The barrier layer can be composed, for example, of a diffusion-reducing polymer, e.g. poly(p-xylylene) (Parylene), which is applied to the surface of the container by suitable methods, e.g. by chemical vapor deposition (CVD). However, the barrier layer preferably contains a metal or a metal compound and is preferably made almost completely of a metal or a metal compound. The metal of the barrier layer can be chosen in particular from the following metals and their alloys: aluminum, titanium, chromium, silver and copper. Aluminum is preferred. Such a barrier layer can be applied to the main body by any desired methods known per se, e.g. by physical vapor deposition (PVD) or chemical vapor deposition (CVD). Suitable coating methods are known from the prior art. In particular, reference is made in this connection to the afore-mentioned documents WO 2006/085063 and EP 1 486 584 and to the prior art discussed therein on the subject of coating methods.

The first and second seal are secured tightly over the respective opening of the main body, in particular adhesively bonded or welded on (e.g. by laser welding, ultrasound welding or other known methods). The barrier layer and the seals preferably overlap in the area in which the respective seal is applied, i.e. at least one of the seals is preferably applied directly or indirectly to the barrier layer of the main body. In particular, the first and/or the second seal can be sealed inductively onto the corresponding application surface. For this purpose, the seal comprises at least one electrically conductive layer and at least one thermoplastic adhesive layer. The seal is pressed onto the relevant application surface and subjected to an electromagnetic alternating field, which induces eddy currents in the conductive layer. The seal heats up in this way, and the adhesive layer is thus softened. An adhesive connection is thereby obtained between the application surface and the seal.

The respective application surface onto which the first or second seal is cohesively bonded preferably extends transversely, in particular perpendicularly, with respect to the longitudinal direction. In order to enlarge the application surface, an inwardly or outwardly protruding application flange extending transversely with respect to the longitudinal direction can be formed at the distal end and/or at the proximal end, which flange enlarges the application surface for the respective seal.

Each of the seals is preferably composed of a relatively thin, flat material, and the two seals can be made of the same material or of different materials. The seals are preferably thin, particularly in relation to the surface covered by the seal, with a thickness of less than 1/10 of the extent perpendicular to the thickness, and preferably thinner than 1 mm. The seals are preferably thinner than the side wall area of the main body in which the piston is displaceable.

The seals can be designed, for example, in the form of a single-layer or multi-layer film or can be formed by a laminate composed of several layers, in which case a layer directed away from the openings, for example, can be a support layer made of paper or cardboard.

Each of the seals also preferably comprises at least one barrier layer. For this barrier layer, the same considerations as for the barrier layer of the main body also apply in principle. In particular, the barrier layer can likewise be composed of a diffusion-reducing polymer or can preferably contain a metal or a metal compound or can be composed substantially of a metal or a metal compound. The barrier layer is preferably composed of a metal, in particular aluminum. However, in contrast to the barrier layer of the main body, the barrier layer is preferably not generated by CVD or PVD methods, but conventionally, for example, by lamination of an aluminum layer onto a suitable support material. Each of the seals can also be made completely of metal.

One or each of the seals can have a weakened area, e.g. a perforation, in order to make breaking easier. Alternatively or in addition, each of the seals can have a tab for pulling the seal off. This tab can be designed to protrude from the main body, in order to make the tab easier to grip.

The coating, the first seal and the second seal together cover preferably at least 90% of the main body, in particular of the outer surface thereof. The outer surface is preferably covered completely by the coating and the seals.

The piston is displaceable in a cylindrical wall area in the main body. The direction in which the piston is displaceable defines a longitudinal direction. In some embodiments, the main body can have at least one flange arranged in the area of the actuation opening and extending transversely with respect to the longitudinal direction, which flange can be used in particular for holding the container with respect to the longitudinal direction during the discharging procedure. In other words, the container can assume an actual syringe shape. When such a flange is present, it is preferable for it to be flush, on the proximal face thereof, with that area of the main body delimiting the actuation opening, and preferable for the second seal to be applied to the flange, i.e. for the holding flange also to serve at the same time as a proximal application flange for the second seal. In this way, the connection surface between container and seal is enlarged.

The container can receive a single product or several separate products. In particular, the container can have at least a second hollow main body, connected to the first main body and with an interior, an outer surface, a distal second outlet opening, and a proximal second actuation opening. In this case, a second piston can be arranged displaceably in the interior of the second main body such that a second product arranged in the interior of the second main body is discharged from the container. Both the first main body and also the second main body then preferably have, on their outer surface, a (preferably common) diffusion-reducing coating, and the second outlet opening and the second actuation opening are likewise closed by in each case a removable or breakable seal. In particular, the first outlet opening and the second outlet opening can be together closed by the first seal, and the first actuation opening and the second actuation opening can be together closed by the second seal.

The container according to the invention can be supplemented by an actuation element to form a discharge device. The actuation element is then designed to cooperate with the piston in the interior of the main body in order to discharge the product from the container. To make it easier to open the seal on the actuation opening, the actuation element can have at least one separating element designed to break the second seal. The separating element can, for example, be a cutting element, a piercing element or a combination of such elements. In particular, the actuation element can comprise a ram extending along a longitudinal direction. This ram is then designed to cooperate at the distal end thereof with a proximal rear face of the piston. The separating element can then comprise a cutting edge arranged in an outer edge area of the distal end and designed to break the second seal in an area directly adjoining the main body. This ensures a clean break of the seal.

A complete discharge device preferably also comprises a container holder, which at least partially receives at least one container of the aforementioned type. A piercing element for the first seal is then preferably present in the container holder, in order to break the first seal when the container is inserted into the container holder or is moved in the distal direction in the container holder. This can in particular be a hollow piercing element that forms a fluid channel for conveying the product held in the container to a withdrawal opening of the container holder. For this purpose, the piercing element can be designed like a spike. A connection structure for the connection of an accessory part, e.g. a cannula, a mixer or a spray head, is preferably formed on the container holder in the area of the withdrawal opening.

A method according to the invention for producing a container comprises the following steps:
providing a hollow main body with an interior, an outer surface, a distal outlet opening, and a proximal actuation opening for inserting an actuation element;
coating the outer surface of the main body with a diffusion-reducing coating;
providing a piston displaceable in the interior of the main body;
filling the interior of the main body with a flowable product in such a way that the content is delimited by the piston in the direction of the proximal actuation opening;
closing the outlet opening by a first removable and/or breakable seal, and
closing the actuation opening by a second removable and/or breakable seal.

The filling procedure is preferably carried out through the outlet opening. For refinements of this method, reference is made to the comments made above concerning the device.

### BRIEF DESCRIPTION OF THE DRAWINGS

Preferred embodiments of the invention are described below with reference to the drawings, which serve only for explanatory purposes and are not to be interpreted as limiting the invention. In the drawings:

FIG. 1 shows a very schematic representation of a container in the from of a single syringe according to a first embodiment of the invention;

FIG. 2 shows a very schematic representation of a container with an alternative design of the seals;

FIG. 3 shows a very schematic representation of a container in the form of a double syringe according to a second embodiment of the invention;

FIG. 4 shows a perspective view of a discharge device according to a third embodiment of the invention, in partial cross section;

FIG. 5 shows a perspective view of a container according to FIG. 4;

FIG. 6 shows the container of FIG. 5 in a perspective sectional view;

FIG. 7 shows the discharge device of FIG. 4 in an exploded view;

FIG. 8 shows, in central longitudinal section, the discharge device of FIG. 4 without accessory part; and

FIG. 9 shows, in central longitudinal section, the discharge device of FIG. 4 after the contents have been discharged.

### DESCRIPTION OF PREFERRED EMBODIMENTS

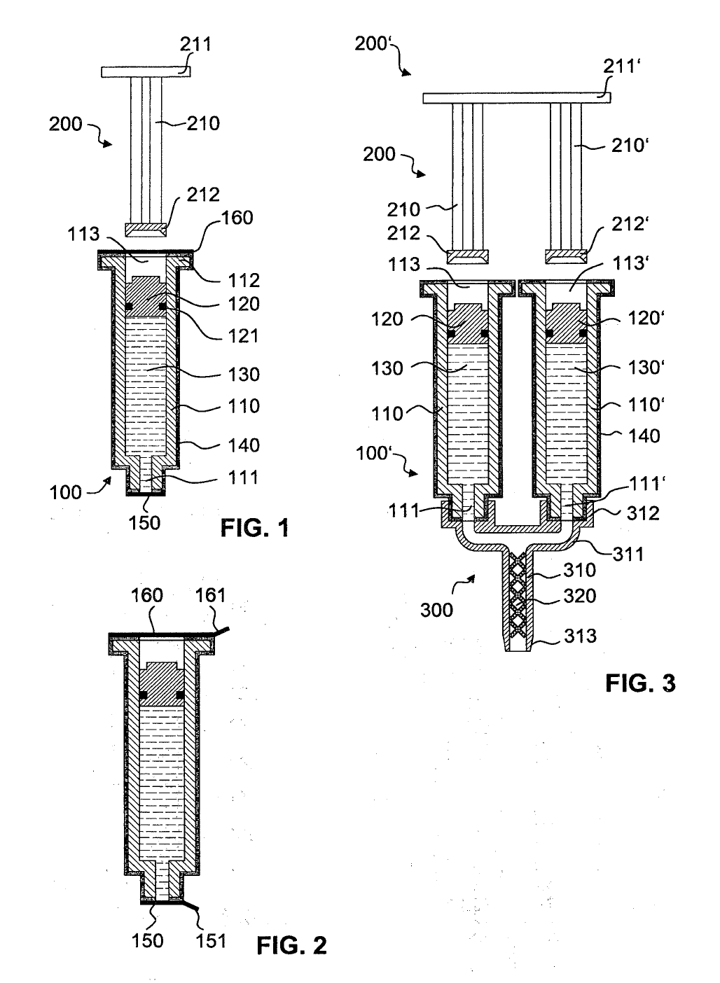

In FIG. 1, a first embodiment of a container 100 is illustrated in highly schematic form. A hollow cylindrical main body (syringe body) 110 has an outlet opening 111 in a narrowed distal end area and has an actuation opening 113 at the opposite, proximal end. In the area of the actuation opening 113, a circumferential and radially outwardly projecting flange 112 is formed in order to permit a better hold of the syringe body 110 in the axial direction. This flange is flush, on the proximal face thereof, with that area of the syringe body surrounding the actuation opening 113. A piston 120 is arranged displaceably in the syringe body 110. The piston 120 is sealed by an O-ring 121 against the inner face of the wall of the syringe body 110. Another kind of seal is of course also possible. On its outer surface, the syringe body 110 has a coating in the form of a metallic barrier layer 140, which extends across the entire surface of the outside of the syringe body except for the openings 111, 113. The coating can be applied using any known method desired.

A first seal 150 is applied, e.g. welded or adhesively bonded, onto the outlet opening. Together with the first seal 150 and the piston 120, the syringe body 110 directly delimits a product-receiving area (product reservoir) in which a flowable product 130, e.g. PMMA, bone cement or another chemically aggressive, volatile or oxygen-sensitive substance, is located. A second seal 160 covers the actuation opening 113 and in this case also the flange 112. Both seals each contain a metallic barrier layer. In the area in which they are applied to the main body, both seals overlap the coating, i.e. the seals are directly connected to the coating. By means of the coating and the seals, the container 100 is hermetically sealed and protected against damaging diffusion processes. In particular, protection against the effects of diffusion is also ensured by the sealed region between the piston 120 and the container wall. For illustrative purposes, the thickness of the coating 140 and of the seals 150, 160 is not shown true to scale in FIG. 1 and is greatly exaggerated. It is also possible for just one of the syringe bodies to be coated.

In order to discharge the product 130 from the container 100, the first seal 150 is removed or broken. To do this, it is pierced, for example, with the aid of an accessory part (not shown) which is fitted onto the outlet and has a hollow spike. In this way, the container is opened directly at the outlet. Moreover, the second seal 160 is removed or pierced. This can be done in particular with the actuation element 200 also shown in FIG. 1. This actuation element 200 is in the form of a ram, which has a piston rod 210. An actuation flange 211 is formed at the proximal end of the ram. At the distal end, the ram has an end area 212 with a shape matching the proximal end of the piston 120. On the radially outer surface of the end area, a circumferential cutting edge is formed which, when the ram is inserted into the container 100, serves to cut through the second seal 160 directly in the area of the container wall. By insertion of the actuation element 200 into the syringe body 110, the piston 120 can now be advanced in the distal direction and the product 130 can be discharged.

An alternative embodiment of the seals is illustrated in FIG. 2. Here, the first seal 150 and the second seal 160 each have a tab 151 and 161, respectively, which is used to pull off the seal from the respective opening.

FIG. 3 is a highly schematic illustration of a second embodiment, in which the container 100′ is designed as a double syringe. Parts having the same function are designated by the same reference numbers as in FIG. 1. In addition to the first syringe body 110, a second syringe body 110′ arranged parallel to the latter is present, with a second outlet opening 111′ and a second actuation opening 113′. In this syringe body, a second piston body 120′ is arranged which, together with the syringe body, delimits a second product-receiving area for a second product 130′. The two syringe bodies 110, 110′ are rigidly connected to each other via a material bridge, not shown in FIG. 3. They are together provided with a coating 140.

In FIG. 3, the double syringe is shown after the seals have been removed. In the area of the outlet openings, a mixer 300 is connected in a securing area 312 to the container 100′. The mixer 300 has a mixing tube 310 with a static mixing element 320 and two feeds 311. The pistons 120, 120′ are actuated by an actuation element 200′ in the form of a double ram, with a first piston rod 210 and a second piston rod 210′, which are connected via a common actuation flange 211′. At its distal end areas 212, 212′, the double ram can again have cutting elements. When the two products are discharged from the two syringe bodies by pressure on the double ram, they pass into the mixer 300 and are there mixed with each other. The mixture then leaves the mixer at a mixer outlet 313.

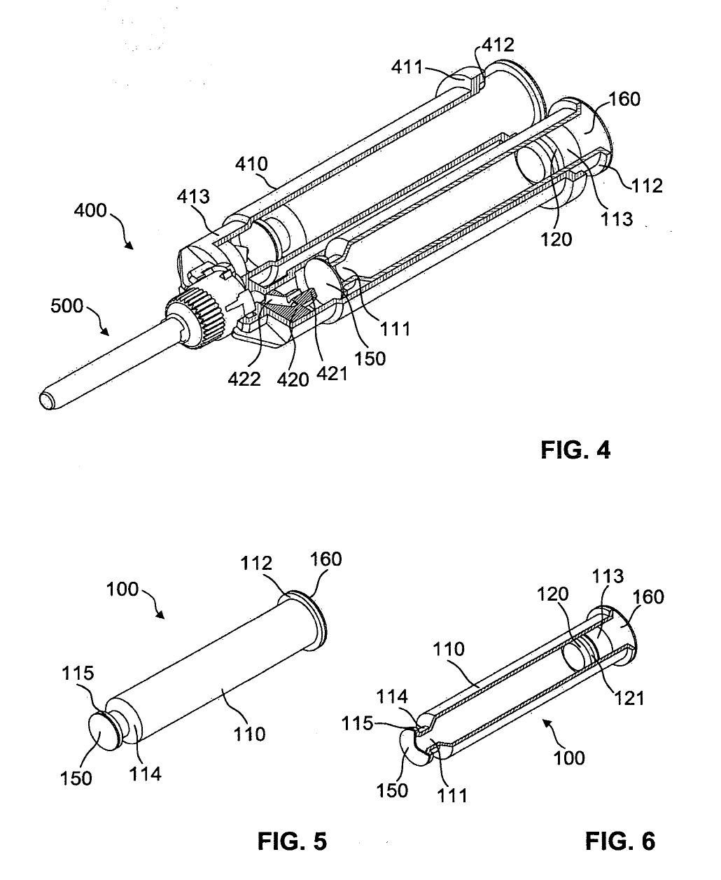

FIGS. 4-9 illustrate various views of a third embodiment of the present invention, in which containers of the type indicated above are fitted in the manner of an exchangeable cartridge into a discharge device. The discharge device shown here comprises two containers 100, which are shown alone in FIGS. 5 and 6, a container holder 400, and an actuation element 430, which is shown alone in FIG. 9. Parts having the same function are designated by the same reference numbers as for the first and second embodiments.

Each of the containers 100 again comprises a hollow main body 110, which is made of plastic and which, on the outer surface thereof, has a diffusion-reducing coating (not shown in FIGS. 4-9). The main body has a cylindrical side wall area which, in the area of the distal end of the container, is adjoined by a narrowed part 114. At the distal end, a radially outwardly protruding first, distal application flange 115 is formed, which radially surrounds the outlet opening 111. At the proximal end, a radially outwardly protruding second, proximal application flange 112 is formed, which radially surrounds the proximal actuation opening 113. In the interior of the cylindrical side wall area of the main body 110, a piston 120 with circumferential seal 121 is once again arranged displaceably in a longitudinal direction.

The distal outlet opening 111 is again closed by a first seal 150. For this purpose, the first application flange 115 forms a first application surface, which extends perpendicularly with respect to the longitudinal direction and onto which the seal 150 is cohesively bonded. The proximal end of the main body 110 is also closed by a second seal 160. For this purpose, the second application flange 112 forms a second application surface, which extends perpendicularly with respect to the longitudinal direction and onto which the second seal 160 is cohesively bonded.

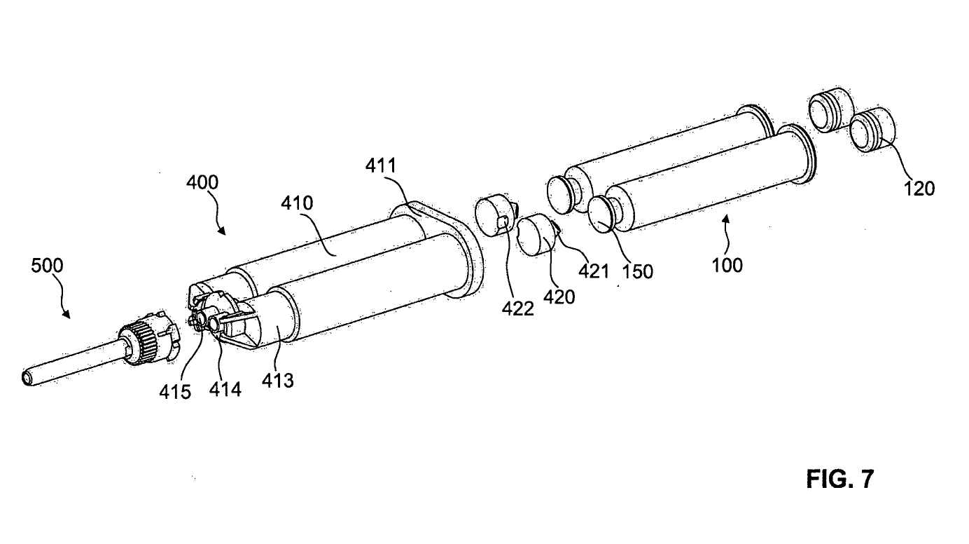

Two containers 100 of the type described above are inserted into the container holder 400. The container holder 400 has two parallel, cylindrical receiving areas 410, into which the two containers are pushed from the direction of the proximal end. An insert 420 is fitted in each case in a distal outlet area 413 of the container holder 400, and a spike-like piercing element 421 facing in the proximal direction is formed on the insert 420. The piercing element 421 is hollow and, together with the rest of the insert, delimits a fluid channel 422, which opens into a respective withdrawal opening 415 (FIG. 7) of the container holder.

As can be seen in FIG. 9, the discharge device additionally comprises an actuation element 430 in the form of a double ram. The actuation element forms, for each of the two pistons 120, a respective piston rod 431, at the distal end of which an advance flange 432 is formed that cooperates with the respective piston 120. At the proximal end, the two piston rods 431 are connected to each other by a common actuation flange 433.

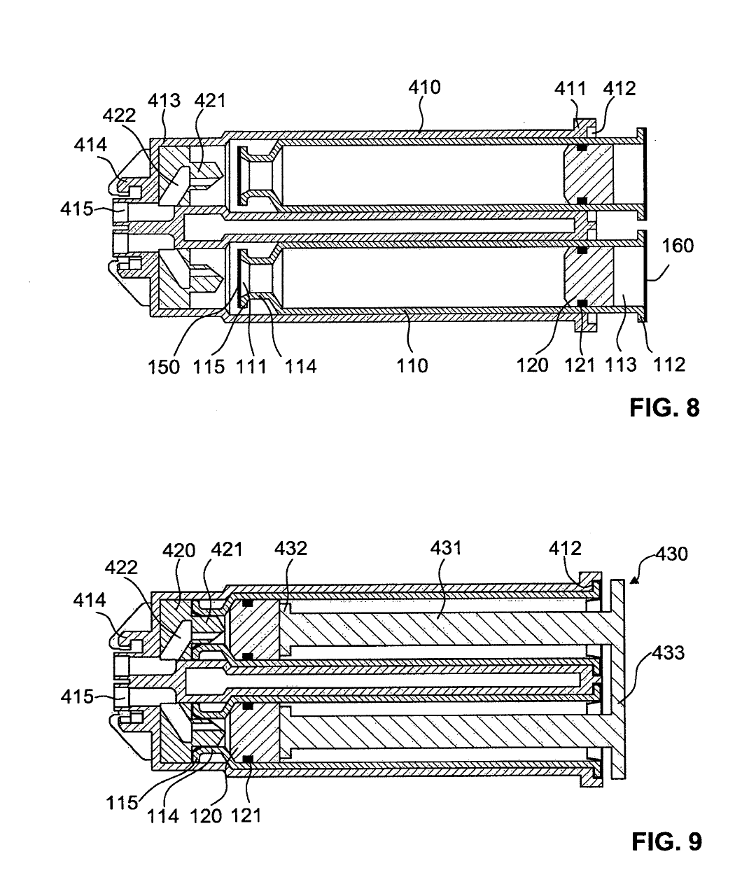

In the position in FIG. 4 and FIG. 8, the two containers 100 are arranged with their respective distal ends at a distance from the respective piercing element 421, and the respective first seals 150 are still intact. A locking element (not shown) can be present in the interior of the container in order to hold the respective container in a releasable locked connection in this storage position.

In order to eject the products from the containers 100, the user first pushes the two containers 100 in the distal direction into the container holder 400. If a locking element of the type mentioned above is present, the user for this purpose overcomes an increased force or releases said locked connection in another way. During the advance movement, the piercing elements 421 pierce the respective first seal 150 and establish a fluid connection between the interior of the respective container and the respective withdrawal opening 415. When the containers are fully pushed in, the proximal application flange 112 bears on an abutment edge 412 of the container holder, which abutment edge 412 is formed by an annular recess in a holding flange 411 of the container holder.

The user then removes the two second (proximal) seals 160 and pushes the actuation element 430 into the actuation openings 113 of the two containers 100 from the direction of the proximal end, in order to advance the two pistons 120 of the containers 100 and thus eject the product held in the respective containers 100 through the respective outlet opening 111. The respective product thus passes through the corresponding fluid channel 422 to the corresponding withdrawal opening 415. The situation at the end of this discharging procedure is shown in FIG. 9.

At the distal end of the container holder 400 there is a connection structure for an accessory part 500, which is here designed as a static mixer. The accessory part receives the ejected products from the withdrawal opening 415, mixes these with each other and dispenses the mixture at its own distal end. The connection of the accessory part 500 to the container holder 400 is provided here by a bayonet-type connection. An accessory part of this kind and its connection to a discharge device are described in detail in particular in document US 2001/0004082, to which reference is expressly made here in respect of the connection of the accessory part to the discharge device. However, the connection between accessory part and container holder can be configured in another known manner, e.g. as a plug connection via Luer cones.

A great many modifications and refinements are of course possible, and the invention is not in any way limited to the above illustrative embodiments. Thus, in particular, container shapes other than the shapes shown here are also possible. If a container holder is used, the latter can of course also be designed differently than in the above third illustrative embodiment and, in particular, can also have other arrangements for attachment of an accessory part. It is of course also conceivable that such a container holder receives only one single container or more than two containers, and that the actuation element is correspondingly designed to advance only a single piston or more than two pistons simultaneously. If the container contains a second product, the latter, instead of being arranged in a second main body parallel to the first main body, can also be present in a differently arranged second reservoir, e.g. in a second receiving area arranged concentrically with respect to a first receiving area. Containers for three or more components are of course also possible.

The coating does not need to be made of aluminum, and instead it can also be made, for example, from other metals, from metal compounds or a plastics barrier layer. It can additionally or alternatively be applied to the inner face of the main body.

The main body does not need to be in one piece, and the wall on which the coating is applied does not necessarily have to be a wall directly delimiting the product. Therefore, more complex designs of the container than the illustrative embodiments shown here are also conceivable.

At the outlet opening, the container can be closed not just by the seal 150 but also by a further closure piece arranged within the seal, e.g. by a stopper or a septum. Many further modifications are possible.

### LIST OF REFERENCE SIGNS

100, 100′ container
110, 110′ main body (syringe body)
111, 111′ outlet opening
112, 112′ flange
113, 113′ actuation opening
114 narrowed part
115 distal application flange
120, 120′ piston
121 O-ring
130, 130′ product
140 barrier layer
150 first seal
151 tab
160 second seal
161 tab
200, 200′ actuation element
210, 210′ piston rod
211, 211′ actuation flange
212, 212′ distal end area
300 mixer
310 mixing tube
311 feed
312 securing area
313 outlet
320 mixing element
400 container holder
410 receiving area
411 holding flange
412 abutment edge
413 distal outlet area
414 connection structure
415 withdrawal opening
420 insert
421 piercing element
422 fluid channel
430 actuation element
431 piston rod
432 advancing flange
433 actuation flange
500 accessory part

1. A container (100; 100′) comprising:
a hollow main body (110) with an interior, an outer surface, a distal outlet opening (111), and a proximal actuation opening (113) for inserting an actuation element (200; 200′); and
a piston (120) arranged displaceably in the interior of the main body (110) for discharging a flowable product (130) arranged in the interior of the main body from the container,
characterized in that the main body (110) has at least one diffusion-reducing barrier layer (140),
in that the outlet opening (111) is closed by a first removable and/or breakable seal (150), and
in that the actuation opening (113) is closed by a second removable and/or breakable seal (160).

2. The container as claimed in claim 1, wherein the barrier layer (140) contains a metal or a metal compound.

3. The container as claimed in claim 1, wherein the first seal (150) and/or the second seal (160) comprise(s) at least one further barrier layer, which contains a metal or a metal compound.

4. The container as claimed in claim 1, wherein the barrier layer (140) of the main body (110), the first seal (150) and the second seal (160) together cover at least 90% of the main body (110).

5. The container as claimed in claim 1, wherein the barrier layer (140) of the main body is applied to the outer surface of the main body (110).

6. The container as claimed in claim 5, wherein the first seal (150) and/or the second seal (160) overlap(s) the barrier layer (140) of the main body (110).

7. The container as claimed in claim 1, wherein the first seal (150) and/or the second seal (160) have/has a tab for removing the seal.

8. The container as claimed in claim 1, wherein the piston (120) is arranged displaceably in the main body (110) along a longitudinal direction, wherein the main body (110) has at least one flange (112), which is arranged in the area of the actuation opening (113) and extends transversely with respect to the longitudinal direction and which, on the proximal face thereof, is flush with an area of the main body (110) delimiting the actuation opening (113), and wherein the second seal (160) is applied to the flange (112).

9. The container as claimed in claim 1, comprising:
at least a second hollow main body (110′), connected to the first main body (110) and with an interior, an outer surface, a distal second outlet opening (111′), and a proximal second actuation opening (113′); and
a second piston (120′) arranged displaceably in the interior of the second main body (110′) for discharging a second product (130′) arranged in the interior of the second main body (110′) from the container,
wherein both the first main body (110) and the second main body (110′) have a diffusion-reducing barrier layer (140),
wherein the second outlet opening (111′) and the second actuation opening (113′) are closed by in each case a removable and/or breakable seal.

10. The container as claimed in claim 9, wherein the first outlet opening (111) and the second outlet opening (111′) are together closed by the first seal.

11. The container as claimed in claim 9, wherein the first actuation opening (113) and the second actuation opening (113′) are together closed by the second seal.

12. A discharge device comprising:
a container (100; 100′) as claimed in claim 1, and
an actuation element (200; 200′) designed to cooperate with the piston (120) in the interior of the main body (110) in order to discharge a product from the container, wherein the actuation element (200; 200′) has at least one separating element (212; 212′) designed to break the second seal (160).

13. The device as claimed in claim 12, wherein the actuation element (200; 200′) comprises a ram extending along a longitudinal direction, wherein the ram has a distal end designed to cooperate with a proximal rear face of the piston (120), and wherein the separating element (212) comprises a cutting edge arranged in an outer edge area of the distal end and designed to break the second seal (160) in an area directly adjoining the main body.

14. A method for producing a container (110; 110′), said method comprising:
providing a hollow main body (110) with an interior, an outer surface, a distal outlet opening (111), and a proximal actuation opening (113) for inserting an actuation element (200; 200′);
coating the main body (110) with a diffusion-reducing barrier layer (140);
providing a piston (120) displaceable in the interior of the main body (110);
filling the interior of the main body (110) with a flowable product (130) in such a way that the content is delimited by the piston (120) in the direction of the proximal actuation opening (113);
closing the outlet opening (111) by a first removable and/or breakable seal (150), and
closing the actuation opening (113) by a second removable and/or breakable seal (160).
